(19) United States
(12) Patent Application Publication
(10) Pub. No.: US 2025/0245647 A1
(43) Pub. Date: Jul. 31, 2025

(54) TERMINAL DEVICE, DATA PROCESSING METHOD AND STORAGE MEDIUM

(71) Applicant: ZTE CORPORATION, Shenzhen, Guangdong (CN)

(72) Inventor: Guotao QU, Shenzhen (CN)

(21) Appl. No.: 18/853,961

(22) PCT Filed: Feb. 9, 2023
(86) PCT No.: PCT/CN2023/075144

§ 371 Date: Oct. 3, 2024

(30) Foreign Application Priority Data
Apr. 26, 2022 (CN) 202210445900.1

(51) Int. Cl. G06Q 20/32; G06Q 20/34

(52) U.S. Cl. CPC G06Q 20/3278; G06Q 20/352

(57) ABSTRACT

Disclosed are a terminal device, a data processing method and a storage medium. The terminal device is provided with a physical radio frequency card, and the terminal device includes: a detection circuit, where the detection circuit detects a first radio frequency signal from a sale terminal; and a built-in near field communication (NFC) unit, where the built-in NFC unit sends a second radio frequency signal to the physical radio frequency card; where the terminal device further controls the built-in NFC unit to send the second radio frequency signal to the physical radio frequency card according to the first radio frequency signal, so as to acquire transaction data of the physical radio frequency card.

### CROSS-REFERENCE TO RELATED APPLICATION(S)

The present disclosure is a national phase entry under 35 USC 371 of International Patent Application No. PCT/CN2023/075114 filed on Feb. 9, 2023, the International Patent application claims a priority of Chinese patent application CN202210445900.1 filed on Apr. 26, 2022, entitled “TERMINAL DEVICE, DATA PROCESSING METHOD AND STORAGE MEDIUM”, and the entire contents of the International Patent Application and the Chinese patent application are incorporated into the present disclosure by reference.

### TECHNICAL FIELD

The present disclosure relates to the technology field of mobile payment, and in particular, to a terminal device, a data processing method and a storage medium.

### BACKGROUND

At present, with the development of near field communication (Near Field Communication, abbreviation: NFC) technology, a consumption behavior of a user is gradually becoming electronic, which has catalyzed a new type of consumption model and business model. In an actual application of NFC technology, a customer user uses a physical radio frequency card or uses a virtual radio frequency card simulated by an NFC module of a mobile terminal to make a consumption payment. However, most merchant users in the consumption market do not support access to the usage of the virtual radio frequency card, and the physical radio frequency card is still a main tool of payment. Therefore, when a ward (e.g., a child) uses a physical radio frequency card to make a consumption payment, a guardian cannot acquire consumption data of a physical radio frequency card in time, which is not conducive to the guardian's consumption supervision.

### SUMMARY

Embodiments of the present disclosure propose a terminal device, a data processing method and a storage medium.

According to an aspect of the present disclosure, the embodiments of the present disclosure provide a terminal device. A physical radio frequency card is provided on a housing of the terminal device. The terminal device includes: a detection circuit, where the detection circuit detects a first radio frequency signal from a sale terminal; and a built-in NFC unit, where the built-in NFC unit sends a second radio frequency signal to the physical radio frequency card. The terminal device further controls the built-in NFC unit to send the second radio frequency signal to the physical radio frequency card according to the first radio frequency signal, so as to acquire transaction data of the physical radio frequency card.

According to an aspect of the present disclosure, the embodiments of the present disclosure further provide a data processing method applied to a first terminal device, where the method includes the following steps: acquiring a first radio frequency signal from a sale terminal; sending a second radio frequency signal to a physical radio frequency card of the first terminal device according to the first radio frequency signal, so as to enable the physical radio frequency card to send transaction data; and acquiring the transaction data.

According to an aspect of the present disclosure, the embodiments of the present disclosure further propose a data processing device, where the device includes: a memory, a processor, a program stored in the memory and executable in the processor, and a data bus for enabling connection and communication between the processor and the memory; where the program, upon being executed by the processor, implements the aforementioned data processing method.

According to an aspect of the present disclosure, the embodiments of the present disclosure further provide a storage medium, configured for computer-readable storage, where the storage medium stores one or more programs, and the one or more programs are executable by one or more processors, so as to implement the aforementioned data processing method.

### BRIEF DESCRIPTION OF THE DRAWINGS

FIG. 1 is a structural block diagram of a terminal device provided by the embodiments of the present disclosure.

FIG. 2 is a structural block diagram of a detection circuit provided by the embodiments of the present disclosure.

FIG. 3 is a flow chart of a data processing method provided by the embodiments of the present disclosure.

FIG. 4 is a flow chart of an application example of a data processing method provided by the embodiments of the present disclosure.

FIG. 5 is a structural block diagram of a data processing device provided by the embodiments of the present disclosure.

### DETAILED DESCRIPTION

It should be understood that the specific embodiments described herein are only used to explain the present disclosure, and are not used to limit the present disclosure.

In the subsequent description, suffixes such as “module”, “component” or “unit” for representing an element are only used for facilitating the explanation of the present disclosure, and have no specific meaning in themselves. Thus, the “module”, the “component” or the “unit” may be used in a mixed manner.

Near field communication (abbreviation: NFC) technology proposed in the embodiments of the present disclosure has an operating frequency of 13.56 MHZ, is a short-range high-frequency wireless communication technology that allows contactless point-to-point data transmission between electronic devices, has a communication distance of 0˜20 cm (within 10 cm for most products in practice), and supports one or several of protocols of type A, type B, and type F.

The embodiments of the present disclosure provide a terminal device, where the terminal device includes: a detection circuit and a built-in NFC unit. A physical radio frequency card is provided on a housing of the terminal device; the detection circuit detects a first radio frequency signal; and the built-in NFC unit sends a second radio frequency signal to the physical radio frequency card. The terminal device further controls the built-in NFC unit to send the second radio frequency signal to the physical radio frequency card according to the first radio frequency signal, so as to acquire transaction data of the physical radio frequency card.

The present disclosure is applied to an occasion where there is a consumption POS (Point Of Sale, a sale terminal) machine, such as a bus, a subway station, a beverage vending machine, etc. The POS machine (sale terminal) and the terminal device may exchange data through the NFC technology, and the terminal device further needs to support a short message or data service. The physical radio frequency card may be a bus card, a work card and a bank card. A main body of the terminal device may be a mobile terminal, and the mobile terminal includes electronic devices such as a mobile phone, a tablet computer, a laptop computer, a desktop computer, a personal digital assistant and a wearable device, etc.

In the current application of NFC technology, a user makes a consumption through a physical radio frequency card, or makes a consumption by using a virtual radio frequency card simulated by an NFC in a mobile phone. The NFC technology has been added to a mobile phone for nearly 10 years, but it is still not practically used due to many non-technical reasons. For example, there is a compatibility problem between a radio frequency NFC antenna of a mobile phone and an antenna of a POS machine; and usage of a virtual radio frequency card requires access permission from a merchant user, and the virtual radio frequency card may be used for consumption after a mobile phone manufacturer or operator needs to complete a debugging work of a POS machine of the merchant user. In a case where most merchant users do not support access to a virtual radio frequency card, the physical radio frequency card has become a main tool for consumption. However, transaction data generated through the usage of a physical radio frequency card by a ward, such as a child, an elderly, etc., cannot be sent to a guardian in real time, which is not conducive for the guardian to tracking and supervising a consumption behavior of the ward. It should be noted that the transaction data includes: a payment amount, payment time, a consumption type and a merchant name.

Based on this, the terminal device proposed in the present disclosure combines a physical radio frequency card, a detection circuit and a built-in NFC unit to achieve real-time monitoring of transaction data of the physical radio frequency card.

As shown in FIG. 1, the embodiments of the present disclosure propose a terminal device 100, where the terminal device 100 includes a housing 101, a card slot 102, and a physical radio frequency card 103. The card slot 102 is disposed on the housing 101, and the card slot 102 may be configured to place the physical radio frequency card 103.

The card slot 102 may be either disposed inside the housing 101 or disposed outside the housing 101. A fixing manner for placing the physical radio frequency card 103 in the card slot 102 includes any suitable manner such as clamping, bonding or welding, etc.

If the card slot 102 is disposed outside the housing 101, and the card slot 102 may be a groove on a visible outer surface of the housing 101. The card slot 102 may also be a pendant of the terminal device 100, and the pendant may be used in cooperation with a rope chain. The card slot 102 may also be disposed on a protective shell of the terminal device 100. In some examples, the card slot 102 may be a gap between the terminal device 100 and the protective shell, with a purpose of ensuring that a distance between the physical radio frequency card 103 and the housing 101 is close enough to ensure that an intensity of a first radio frequency signal received by the physical radio frequency card 103 is substantially the same as an intensity of the first radio frequency signal received by the terminal device 100, so as to guarantee that the terminal device 100 can accurately determine whether the physical radio frequency card 103 enters an external radio frequency field.

If the card slot 102 is disposed inside the housing 101, the card slot 102 may be a groove on an invisible inner surface of the housing 101. The card slot 102 may also be an embedding slot on a circuit board of the terminal device 100. In some examples, an embedding opening of the card slot 102 is on an invisible outer surface of the housing 101, and the physical radio frequency card 103 may be embedded into an inside of the housing 101 through the embedding opening.

It should be noted that the physical radio frequency card 103 may be a card that may enable a transaction, such as a bus card, a work card or a bank card, etc., and the protective shell may be a decoration that protects or decorates an appearance of the terminal device 100.

In some exemplary embodiments, the terminal device 100 may further include a detection circuit and a built-in NFC unit.

The detection circuit and the built-in NFC unit may be disposed inside the terminal device 100 wrapped by the housing 101. The terminal device 100 determines whether the physical radio frequency card 103 on the terminal device 100 enters an external radio frequency field through the detection circuit. The external radio frequency field is a radio frequency field generated by a sale terminal. When a user uses the physical radio frequency card 103 to make a consumption, the physical radio frequency card 103 enters the external radio frequency field, and in order to prevent a transaction process from being interfered, the terminal device 100 turns off an NFC function of a mobile phone. Based on this, it can be ensured that data is transmitted stably when the physical radio frequency card 103 interacts with the sale terminal, and further, a user can swipe a card normally. After the physical radio frequency card 103 is out of the external radio frequency field, the terminal device 100 can automatically turn on the built-in NFC unit of the mobile phone to read transaction data of the physical radio frequency card 103, and send the transaction data to a target user through a manner, such as a short massage, etc., so as to ensure that the target user can instantly learn a status of a monitored physical radio frequency card 103 without a long delay.

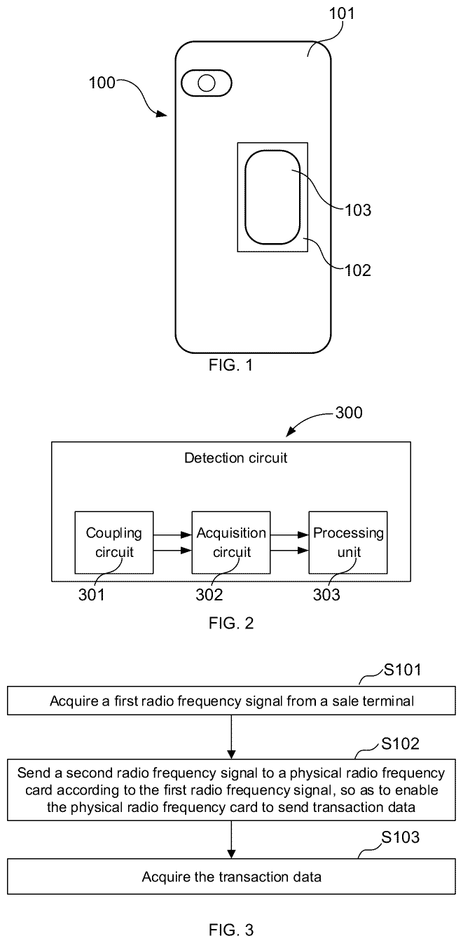

As shown in FIG. 2, the present disclosure proposes a detection circuit 300, where the detection circuit 300 includes: a coupling circuit 301, an acquisition circuit 302, and a processing unit 303.

A working principle of the coupling circuit 301 is the inductance coupling principle. The coupling circuit 301 detects a first radio frequency signal and converts a magnetic field energy of an external radio frequency field into an electrical energy. The coupling circuit 301 includes an induction coil. The induction coil may be an antenna of a built-in NFC unit in the terminal device 100 or an independently installed coil. If the induction coil and the built-in NFC unit share a same antenna, when the built-in NFC unit is turned off, the antenna is used as a part of the coupling circuit 301; and when the built-in NFC unit is turned on, the antenna is also used as the antenna of the built-in NFC unit.

Exemplarily, the physical radio frequency card 103 may be a bank card, and the external radio frequency field may be generated by a POS machine. When the bank card enters the external radio frequency field, both the bank card and the coupling circuit 301 can receive the first radio frequency signal. The coupling circuit 301 converts the first radio frequency signal into an induced electrical signal such as a current signal or a voltage signal, etc. The terminal device 100 can determine whether the bank card has been swiped according to the induced electrical signal. In order to prevent a false alarm, the terminal device 100 may determine whether the bank card has been swiped according to whether an amplitude of a voltage or an amplitude of a current generated on the coil reaches a preset threshold value; and since a continuous magnetic field energy is generated when the radio frequency NFC card is swiped, the terminal device 100 may also determine whether the bank card has been swiped according to a length of generating time of an induced voltage or current.

Since the induced electrical signal acquired by the induction coil is usually a weak signal with noise, and cannot be directly observed and analyzed, it is necessary to perform signal shaping, such as rectification, filtering, and amplification, etc., on the induced electrical signal, to remove the noise in the signal, so as to make the induced electrical signal to be a characteristic electrical signal in a stable state. The characteristic electrical signal records characteristic information of the first radio frequency signal and can reflect a changing rule of the first radio frequency signal.

The acquisition circuit 302 converts the induced electrical signal into a characteristic electrical signal, and transfers the characteristic electrical signal to the processing unit 303. The acquisition circuit 302 acquires the induced electrical signal generated by the coupling circuit 301, and performs signal shaping on the induced electrical signal through an amplifier, a filter, and a triode circuit, etc. For example, the noise of the induced electrical signal is removed through the filter, and the induced electrical signal is provided with excitation through the amplifier, so as to generate the characteristic electrical signal. The characteristic electrical signal after signal shaping may be analyzed by the processing unit 303. Finally, the characteristic electrical signal is transferred to the processing unit 303 through the acquisition circuit 302.

The processing unit 303 analyzes the characteristic electrical signal to acquire characteristic information of the first radio frequency signal, so as to determine whether the terminal device 100 has entered an external radio frequency field. The processing unit 303 may be an application processor (abbreviation: AP) of the terminal device 100, or may also be other processors of the terminal device 100.

Taking the induced electrical signal as a voltage as an example, when a user makes a consumption through the physical radio frequency card 103 of the terminal device 100, the terminal device 100 enters an external radio frequency field, the coupling circuit 301 generates an induced voltage, where the induced voltage is converted into a characteristic voltage through the acquisition circuit; and when a consumption of the physical radio frequency card 103 is completed, the induced voltage disappears. The smaller a distance between the terminal device 100 and the sale terminal is, the greater the induced voltage is. When the distance between the terminal device 100 and the sale terminal reaches a preset distance, the physical radio frequency card 103 on the housing 101 of the terminal device 100 can exchange data with the sale terminal to achieve a consumption payment, and the induced voltage at this time is set as a reference value. When an acquired induced voltage is greater than or equal to the reference value, the physical radio frequency card 103 is considered to have entered the external radio frequency field of the sale terminal. Therefore, a processor can determine whether the physical radio frequency card 103 enters or exits the external radio frequency field according to a level of the characteristic voltage.

In other embodiments, the processor may further process and analyze an induced electrical signal such as a current signal or an interrupt signal, etc. Since a continuous magnetic field energy is generated when the physical radio frequency card 103 is swiped, the processor may also use a length of generating time of an induced voltage or current, as a determination criterion. The processor may determine whether the terminal device 100 enters or exits a radio frequency field according to any one or more induced electrical signals.

The processing unit 303 determines whether the physical radio frequency card 103 enters or exits the external radio frequency field according to the characteristic electrical signal. When the physical radio frequency card 103 enters the external radio frequency field to make a consumption payment, the characteristic electrical signal received by the processing unit 303 is greater than or equal to a preset intensity, and the built-in NFC unit of the terminal device 100 should be turned off to prevent interfering with the consumption payment of the physical radio frequency card 103 with the POS machine. When the physical radio frequency card 103 leaves the external radio frequency field, the characteristic electrical signal received by the processing unit 303 changes from greater than or equal to the preset intensity to less than the preset intensity, and the built-in NFC unit of the terminal device 100 should be started to read transaction data of the physical radio frequency card 103 in time. For example, after an interval of 1 second from that the physical radio frequency card 103 is recognized to leave the external radio frequency field, the built-in NFC unit is started to send a second radio frequency signal to the physical radio frequency card to read the transaction data of the physical radio frequency card 103, where the interval may be set manually.

The built-in NFC unit sends the second radio frequency signal to the physical radio frequency card 103 to make the physical radio frequency card 103 post back the transaction data, and further acquires the transaction data posted back by the physical radio frequency card 103 and transfers the transaction data to an application processor of the terminal device 100.

The terminal device 100 further includes an application at a mobile phone side. When the application is installed in the terminal device 100, the terminal device 100 needs to grant a corresponding authority. For example, the terminal device 100 may acquire authorities of current location information, a user's mobile phone number, an instant messaging software account and network information.

The terminal device 100 may generate notification information according to the transaction data and related information through the application, and send the notification information to the target user. For example, the notification information is generated according to the transaction data and the current location information.

Based on this, the terminal device 100 proposed in the embodiments of the present disclosure can acquire, in real time, the transaction data generated when a ward uses the physical radio frequency card 103 for consumption, and send the transaction data to a guardian, so as to solve the problem of untimely and incomplete message notification of the physical radio frequency card 103, thereby improving the consumption supervision ability of the guardian.

As shown in FIG. 3, the present embodiment provides a data processing method, and the data processing method is applied to the above-mentioned terminal device. Steps of the method may include the following operations: S101 to S103.

In S101, a first radio frequency signal is acquired from a sale terminal.

In the current application of the NFC technology, a user makes a consumption through a physical radio frequency card, or makes a consumption by using a virtual radio frequency card simulated by the NFC in a mobile phone. The NFC technology has been added to a mobile phone for nearly 10 years, but it is still not practically used due to many non-technical reasons. For example, there is a compatibility problem between a radio frequency NFC antenna of a mobile phone and an antenna of a POS (Point Of Sale, a sale terminal) machine; and usage of a virtual radio frequency card requires an access permission from a merchant user, and a virtual radio frequency card may be used for consumption after a mobile phone manufacturer or operator needs to complete a debugging work of the POS machine of the merchant user. In a case where most merchant users do not support access of a virtual radio frequency card, the physical radio frequency card has become a main tool for consumption. However, transaction data generated by the usage of a physical radio frequency card by a ward, such as a child, an elderly, etc., cannot be sent to a guardian in real time, which is not conducive for the guardian to tracking and supervising a consumption behavior of the ward. It should be noted that the transaction data includes: a payment amount, payment time, a consumption type and a merchant name.

Based on this, the data processing method proposed in the present disclosure can monitor transaction data of a physical radio frequency card in real time through a physical radio frequency card, a detection circuit and a built-in NFC unit on a terminal device.

The terminal device includes a physical radio frequency card, a detection circuit and a built-in NFC unit. The detection circuit includes: a coupling circuit, an acquisition circuit and a processing unit. The physical radio frequency card is disposed in a place such as a housing that is close enough in distance to a mobile phone, so as to ensure that an intensity of the first radio frequency signal received by the physical radio frequency card is substantially the same as an intensity of the first radio frequency signal received by the mobile phone. The terminal device may be a mobile phone. When the physical radio frequency card enters an external radio frequency field generated by the sale terminal, the first radio frequency signal output by the POS machine is acquired through an induction coil in the coupling circuit in the mobile phone.

A working principle of the coupling circuit is the induction coupling principle. The coupling circuit may detect the first radio frequency signal and convert a magnetic field energy of an external radio frequency field into electrical energy. The coupling circuit includes an induction coil. The induction coil may be an antenna of the built-in NFC unit in the terminal device or an independently installed coil. If the induction coil and the built-in NFC unit share the same antenna, when the built-in NFC unit is turned off, the antenna is used as a part of the coupling circuit; and when the built-in NFC unit is turned on, the antenna is also used as the antenna of the built-in NFC unit.

The physical radio frequency card may be a bank card, and the external radio frequency field is generated by a POS machine. When the bank card enters the external radio frequency field, both the bank card and the coupling circuit can receive the first radio frequency signal, and the physical radio frequency card completes a transaction with the sale terminal in the external radio frequency field. The coupling circuit converts the first radio frequency signal into an induced electrical signal such as a current signal or a voltage signal, etc. The terminal device can determine whether the bank card has been swiped according to the induced electrical signal.

Since the induced electrical signal acquired by the induction coil of the coupling circuit is usually a weak signal with noise, and cannot be directly observed and analyzed, it is necessary to perform signal shaping, such as rectification, filtering, and amplification, on the induced electrical signal, so as to remove the noise in the signal and make the induced electrical signal to be a characteristic electrical signal in a stable state. The characteristic electrical signal records characteristic information of the first radio frequency signal and can reflect a changing rule of the first radio frequency signal.

It should be noted that the physical radio frequency card may be a bus card, a work card and a bank card, and a main body of the terminal device may also be other mobile terminals, and the mobile terminal includes electronic devices such as a mobile phone, a tablet computer, a laptop computer, a desktop computer, a personal digital assistant and a wearable device, etc.

In this way, perception of an external radio frequency field by the physical radio frequency card and the mobile phone can be carried out synchronously, so as to acquire transaction status information of the physical radio frequency card in a subsequent process.

In S102, a second radio frequency signal is sent to a physical radio frequency card according to the first radio frequency signal, so as to enable the physical radio frequency card to send transaction data.

In order to prevent a false alarm, the terminal device may determine whether the bank card has been swiped according to whether an amplitude of a voltage or an amplitude of a current generated on the coil reaches a preset threshold value; and since a continuous magnetic field energy is generated when the radio frequency NFC card is swiped, the terminal device can also determine whether the bank card has been swiped according to a length of generating time of an induced voltage or current.

An induced electrical signal is converted into a characteristic electrical signal through the acquisition circuit on the mobile phone, and the characteristic electrical signal is transferred to the processing unit. The acquisition circuit acquires the induced electrical signal generated by the coupling circuit, and performs signal shaping on the induced electrical signal through an amplifier, a filter, a triode circuit, etc. For example, the noise of the induced electrical signal is removed through a filter, and the induced electrical signal is provided with excitation through an amplifier. The characteristic electrical signal after signal shaping can be analyzed by the processing unit. Finally, the characteristic electrical signal is transferred to the processing unit through the acquisition circuit.

Since the induced electrical signal acquired by the induction coil is usually a weak signal with noise, and cannot be directly observed and analyzed, it is necessary to perform signal shaping, such as rectification, filtering, and amplification, on the induced electrical signal, so as to remove the noise in the signal and make the induced electrical signal to be a characteristic electrical signal in a stable state. The characteristic electrical signal records characteristic information of the first radio frequency signal and can reflect a changing rule of the first radio frequency signal.

The acquisition circuit performs signal shaping on the induced electrical signal through an amplifier, a filter, and a triode circuit, etc. For example, the noise of the induced electrical signal is removed through the filter, and the induced electrical signal is provided with excitation through the amplifier. A characteristic electrical signal after signal shaping may be analyzed by the processing unit. Finally, the characteristic electrical signal is transferred to the processing unit through the acquisition circuit.

The characteristic electrical signal is analyzed by the processing unit to acquire characteristic information of the first radio frequency signal, so as to determine whether the terminal device has entered a radio frequency field. The processing unit may be an application processor (abbreviation: AP) of the terminal device, or may also be other processors of the terminal device.

The smaller a distance between the terminal device and the sale terminal is, the greater a signal intensity of the first radio frequency signal received by the terminal device is. When the signal intensity of the first radio frequency signal received by the physical radio frequency card reaches a preset value, the physical radio frequency card can be considered to complete a payment at the sale terminal. Therefore, when the terminal device detects that the first radio frequency signal is greater than or equal to a preset intensity, the built-in NFC unit is turned off to prevent an internal radio frequency field generated by the built-in NFC unit from interfering with the transaction process. Since the first radio frequency signal is converted to obtain an induced electrical signal, and the induced electrical signal is amplified by the acquisition circuit to obtain a characteristic electrical signal, the signal intensity of the first radio frequency signal can be obtained by converting the characteristic electrical signal. When the processing unit detects that the first radio frequency signal is less than the preset intensity, the built-in NFC unit is turned on, and a second radio frequency signal is sent to the physical radio frequency card through the built-in NFC unit.

Taking the induced electrical signal as a voltage as an example, when a user makes a consumption through the physical radio frequency card of the terminal device, the terminal device enters an external radio frequency field, the coupling circuit generates an induced voltage, and the induced voltage is converted into a characteristic voltage through the acquisition circuit, and when consumption of the physical radio frequency card is completed, the induced voltage disappears. Therefore, the processor may determine whether the physical radio frequency card enters or exits the external radio frequency field according to a level of the characteristic voltage.

In other embodiments, the induced electrical signal may also be a current signal or a voltage signal is taken as an interrupt signal. Since a continuous magnetic field energy is generated when the physical radio frequency card is swiped, a length of generating time of the induced voltage or current may be taken as a determination criterion. The processor may determine whether the terminal device enters or exits the radio frequency field according to any one type or more types of solutions.

In some embodiments, when a bank card is close to a POS machine for a consumption payment, the built-in NFC unit of the terminal device should be turned off to prevent interference with the consumption payment of the bank card with the POS machine. When the physical radio frequency card leaves the external radio frequency field, the built-in NFC unit of the terminal device should be automatically turned on to read the transaction data of the physical radio frequency card in time.

The second radio frequency signal is sent to the physical radio frequency card by the built-in NFC unit, so that the physical radio frequency card posts back the transaction data, the transaction data posted back by the physical radio frequency card is acquired, and the transaction data is transferred to an application processor of the terminal device.

In this way, consumption monitoring and consumption data processing of the physical radio frequency card are achieved without interfering with the consumption of the physical radio frequency card.

In S103, the transaction data is acquired.

The terminal device further includes an application at a mobile phone side. When the application is installed in the terminal device, the terminal device needs to grant a corresponding authorization. For example, the terminal device may acquire current location information, a user's mobile phone number, an instant messaging software account and network information permission.

Notification information is generated by using the application according to the transaction data and the current location information, and the notification information is sent to a target user.

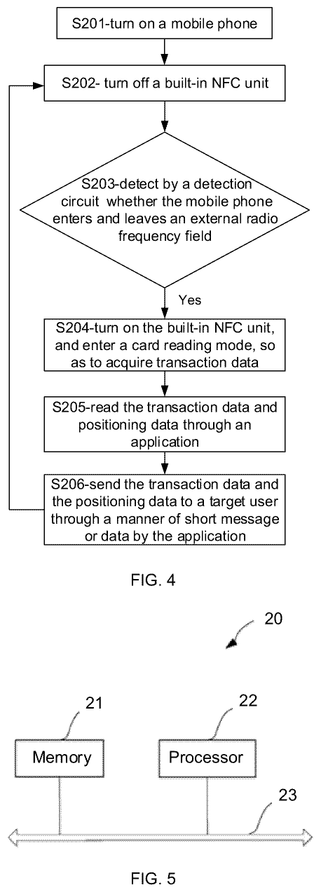

As shown in FIG. 4, the present disclosure further proposes a flowchart of an application example of a data processing method, and steps of the application example include: S201 to S206.

In S201, a mobile phone is turned on.

In S202, a built-in NFC unit of the mobile phone is turned off.

In S203, a detection circuit detects whether the mobile phone enters and leaves an external radio frequency field. If the mobile phone is detected to enter the external radio frequency field, step S204 is proceeded.

In S204, the built-in NFC unit is turned on, and a card reading mode is entered to acquire transaction data from a physical radio frequency card.

In S205, the transaction data and positioning data are acquired through an application.

In S206, the transaction data and the positioning data are sent to a target user through a manner of short message or data by the application. After completing sending the transaction data and the positioning data, step S202 is returned.

The data processing method proposed in the embodiments of the present disclosure can solve the problem of untimely and incomplete message notification of a physical radio frequency card, and can also solve the problem that a virtual radio frequency card cannot be used due to a non-technical reason. When a ward uses a terminal device, the guardian can learn about the ward's consumption status and current address in time, and can therefore monitor the ward's transaction in time.

As shown in FIG. 5, the embodiments of the present disclosure propose a data processing device 20, where the device 20 includes a memory 21, a processor 22, a program stored in the memory and executable on the processor, and a data bus 23 for enabling connection and communication between the processor 21 and the memory 22.

The program, upon being executed by the processor, implements the above steps as shown in FIG. 3: acquiring a first radio frequency signal; sending a second radio frequency signal to a physical radio frequency card according to the first radio frequency signal, so as to enable the physical radio frequency card to send transaction data; and acquiring the transaction data.

In some embodiments, the data processing device 20 may further achieve: sending the transaction data to a target user.

In some embodiments, the data processing device 20 may further achieve: acquiring current location information of the terminal device and sending the current location information and transaction data to a target user.

In some embodiments, the data processing device 20 may further achieve: turning off a built-in NFC unit when it is detected that the first radio frequency signal is greater than or equal to a preset intensity.

In some embodiments, the data processing device 20 may further achieve: turning on a built-in NFC unit when it is detected that the first radio frequency signal is smaller than a preset intensity and sending a second radio frequency signal to a physical radio frequency card through the built-in NFC unit.

The embodiments of the present disclosure propose a computer-readable storage medium, where the computer-readable storage medium stores one or more programs, and the one or more programs are executable by one or more processors to implement any data processing method provided by the embodiments of the present disclosure.

The computer-readable storage medium may be an internal storage unit of a computer device of the aforementioned embodiments, such as a hard disk or a memory of the computer device. The computer-readable storage medium may also be an external storage device of a computer device, such as a plug-in hard disk, a smart media card (SMC), a secure digital (SD) card, a flash card, etc., equipped on the computer device.

Based on a terminal device, a data processing method, a device and a storage medium proposed in the embodiments of the present disclosure, a physical radio frequency card is bound with a mobile terminal, the mobile terminal is used to monitor and acquire consumption data of the physical radio frequency card, and the consumption data and current location of the mobile terminal is sent to a target user, so that the problem of untimely and incomplete message notification of the physical radio frequency card can be solved, and the problem that a virtual radio frequency card cannot be used due to a non-technical reason can further be solved. When a ward uses a terminal device, a guardian can instantly learn about the ward's consumption status and current position where the ward is located, and can therefore monitor the ward's transaction in time.

It should be understood by those skilled in the art that, all or some of the steps in the method, the function modules/units in the system and the device disclosed above may be implemented as a software, a firmware, a hardware, and a suitable combination thereof.

In hardware implementations, the division between functional modules/units mentioned in the above description does not necessarily correspond to the division of physical components; for example, one physical component may have multiple functions, or one function or step may be performed by several physical components in cooperation. Some or all of the physical components may be implemented as a software executed by a processor, such as a central processor, a digital signal processor or a microprocessor, or implemented as a hardware, or implemented as an integrated circuit, such as an application specific integrated circuit. Such software may be distributed on a computer-readable medium, and the computer-readable medium may include a computer storage medium (or a non-transitory medium) and a communication medium (or a transitory medium). As well known to those skilled in the art, the term, computer storage medium, includes volatile and non-volatile, removable and non-removable media implemented in any method or technology for storing information (e.g., computer-readable instructions, data structures, program modules or other data). The computer storage medium includes, but is not limited to, RAM, ROM, EEPROM, flash or other memory technologies, CD-ROM, digital versatile disk (DVD) or other optical disk storages, magnetic cassettes, tapes, disk storages or other magnetic storage means, or any other medium that may be used to store desired information and may be accessed by a computer. In addition, it is well known to those skilled in the art that, a communication medium generally includes computer-readable instructions, data structures, program modules or other data in a modulation data signal such as a carrier wave or other transmission mechanisms, and may include any information delivery medium.

The optional embodiments of the present disclosure are described above with reference to the accompanying drawings, but the scope of rights of the present disclosure is not limited thereby. Any modification, equivalent replacement and improvement made without departing from the scope of the present disclosure shall be within the scope of the rights of the present disclosure.

1. A terminal device, wherein the terminal device is provided with a physical radio frequency card, and the terminal device comprises:
a detection circuit, the detection circuit detecting a first radio frequency signal from a sale terminal; and
a built-in near field communication (NFC) unit, the built-in NFC unit sending a second radio frequency signal to the physical radio frequency card;
wherein the terminal device further controls the built-in NFC unit to send the second radio frequency signal to the physical radio frequency card according to the first radio frequency signal, so as to acquire transaction data of the physical radio frequency card.

2. The terminal device according to claim 1, wherein the terminal device comprises a housing, the housing comprises a card slot, and the card slot is configured to place the physical radio frequency card.

3. The terminal device according to claim 1, wherein the detection circuit comprises a coupling circuit, an acquisition circuit and a processing unit; and
the coupling circuit comprises an induction coil to generate the induced electrical signal according to a detected first radio frequency signal and outputs the induced electrical signal to the acquisition circuit;
the acquisition circuit converts the induced electrical signal into a characteristic electrical signal, and outputs the characteristic electrical signal to the processing unit; and
the processing unit turns off the built-in NFC unit in a case where the characteristic electrical signal is greater than or equal to a preset intensity, or controls the terminal device to send the second radio frequency signal to the physical radio frequency card after the characteristic electrical signal changes from greater than or equal to the preset intensity to less than the preset intensity.

4. A data processing method, applied to a first terminal device, wherein
the data processing method comprises:
acquiring a first radio frequency signal from a sale terminal;
sending a second radio frequency signal to a physical radio frequency card of the first terminal device according to the first radio frequency signal, so as to enable the physical radio frequency card to send transaction data; and
acquiring the transaction data.

5. The data processing method according to claim 4, further comprising:
sending the transaction data to a second terminal device of a guardian corresponding to a ward using the first terminal device.

6. The data processing method according to claim 5, further comprising:
acquiring current location information of the first terminal device, and sending the current location information to the second terminal device of the guardian corresponding to the ward using the first terminal device.

7. The data processing method according to claim 4, wherein the first terminal device comprises a built-in near field communication (NFC) unit, the built-in NFC unit sending a second radio frequency signal to the physical radio frequency card, and the data processing method further comprises:
turning off the built-in NFC unit in a case where the first radio frequency signal being greater than or equal to a preset intensity is detected.

8. The data processing method according to claim 4, wherein the first terminal device comprises a built-in near field communication (NFC) unit, and the sending the second radio frequency signal to the physical radio frequency card according to the first radio frequency signal, comprises:
turning on the built-in NFC unit in a case where the first radio frequency signal being less than a preset intensity, and sending, by the built-in NFC unit, the second radio frequency signal to the physical radio frequency card.

9. A terminal device, wherein the device comprises: a memory, a processor, a program stored in the memory and executable on the processor, and a data bus for enabling connection and communication between the processor and the memory, wherein the program, upon being executed by the processor, implements;
acquiring a first radio frequency signal from a sale terminal;
sending a second radio frequency signal to the physical radio frequency card of the terminal device according to the first radio frequency signal, so as to enable the physical radio frequency card to send transaction data; and
acquiring the transaction data.

10. A non-transitory computer-readable storage medium, configured for computer-readable storage, wherein the storage medium stores one or more programs, wherein the one or more programs are executable by one or more processors, so as to implement the data processing method according to claim 4.

11. The terminal device according to claim 2, wherein the card slot is provided on an outer surface or an inner surface of the housing, or on a circuit board of the terminal device.

12. The terminal device according to claim 3, wherein the induction coil is an antenna of the built-in NFC unit.

13. The terminal device according to claim 3, wherein the induction coil is an independently installed coil.

14. The data processing method according to claim 4, wherein the first terminal device comprises a detection circuit, the detection circuit detecting a first radio frequency signal from a sale terminal; and a built-in near field communication (NFC) unit; the detection circuit comprises a coupling circuit, an acquisition circuit and a processing unit; and the coupling circuit comprises an induction coil;
the sending, the second radio frequency signal to the physical radio frequency card of the first terminal device according to the first radio frequency signal, comprises;
generating, by the coupling circuit through using the induction coil, the induced electrical signal according to the first radio frequency signal, and outputting the induced electrical signal to the acquisition circuit;
converting, by the acquisition circuit, the induced electrical signal into a characteristic electrical signal, and outputting the characteristic electrical signal to the processing unit; and
turning off, by the processing unit, the built-in NFC unit in a case where the characteristic electrical signal is greater than or equal to a preset intensity, or controlling the the built-in NFC unit to send the second radio frequency signal to the physical radio frequency card after the characteristic electrical signal changes from greater than or equal to the preset intensity to less than the preset intensity.

15. The data processing method according to claim 14, further comprising determining whether to turn off or turn on the built-in NFC unit according to a length of generating time of an induced voltage or current.

16. The data processing method according to claim 14, wherein the transaction data is obtained through the built-in NFC unit.

17. The data processing method according to claim 16, wherein after determining the physical radio frequency card leaves an external radio frequency field generated by the sales terminal, the built-in NFC unit sends the transaction data to a processor of the first terminal device.

18. The data processing method according to claim 16, wherein after a first time interval from determining the physical radio frequency card leaves an external radio frequency field generated by the sales terminal, the built-in NFC unit sends the transaction data to a processor of the first terminal device.

19. The data processing method according to claim 6, wherein the first terminal device generates notification information based on the transaction data and the current location information and sends the notification information to a second terminal device of a guardian corresponding to a ward using the first terminal device.

20. The data processing method according to claim 19, wherein the first terminal device sends the notification information to the second terminal device of the guardian corresponding to the ward using the first terminal device through a short message.
